(19) United States
(12) Patent Application Publication
(10) Pub. No.: US 2007/0094863 A1
(43) Pub. Date: May 3, 2007

(54) Wound coil and surface-mounted coil

(75) Inventors: Shigeru Ogawa, Nagaoka-shi (JP); Takaichi Suzuki, Nagaoka-shi (JP)

Correspondence Address: SUGHRUE MION, PLLC, 2100 PENNSYLVANIA AVENUE, N.W., SUITE 800, WASHINGTON, DC, 20037, US

(73) Assignee: Yugen Kaisha NOC

(21) Appl. No.: 11/588,301

(22) Filed: Oct. 27, 2006

(30) Foreign Application Priority Data
Oct. 31, 2005 (JP) 2005-317349
Jun. 30, 2006 (JP) 2006-182755
Aug. 11, 2006 (JP) 2006-220093

(51) Int. Cl. H01F 7/06

(52) U.S. Cl. 29/605

(57) ABSTRACT

The present invention provides a new and innovative technique for attaining satisfactory attenuation characteristics. The present invention provides a wound coil made by winding a conductive wire (2) around a core (3), wherein the core (3) is shaped having a tapered part (11) in which the outside diameter of the core (3) gradually decreases so that the diameter of the conductive wire (2) wound around the core (3) is not constant but instead gradually decreases; and the tapered part (11) is not tapered so that the outside diameter of the core (3) decreases at a constant rate from a large proximal end to a small distal end of the tapered part (11), but rather the tapered part (11) is formed into a tapered shape wherein the rate of decrease in the outside diameter of the core (3) is gradually reduced from the large proximal end to the small distal end; i.e., the tapered part (11) decreases in diameter at a high rate at the proximal end, and decrease in diameter at a lower rate in the distal end than in the proximal end.

### BACKGROUND OF THE INVENTION

1. Field of the Invention

The present invention relates to a wound coil wherein a conductive wire is wound around a core that is intended to have inductance, and to a surface-mounted coil mounted on a printed wiring board or another substrate, for example.

2. Description of the Related Art

Wound coils (inductors), referred to as core coils, are generally made by winding a conductive wire around a core composed of ferrite or a semiconductor, for example (additionally, some coils are made by filling an air-core coil with a mixture of a resin and an iron powder).

A common conventional wound coil has a configuration in which the conductive wire is wound around the outer peripheral surface of the core, which is cylindrical and has a constant outside diameter. The diameter of the wound conductive wire is therefore also constant, and, consequently, each wound coil will only have a single resonance frequency.

Therefore, although a wound coil in which the core has a constant outside diameter can exhibit the functions of a coil (can have significant attenuation) due to a favorable increase in impedance in this resonance frequency band, the impedance is immediately lowered and the coil functions are markedly impaired (attenuation is significantly reduced) outside of this resonance frequency band. Consequently, favorable inductor characteristics can be attained (significant attenuation can be achieved) only in an extremely small frequency band.

Accordingly, the only option has been to link multiple wound coils having different resonance frequencies in order to obtain significant attenuation in a wide frequency band. This leads to proportionately increased costs and requires a large amount of space for assembly, which has been a pressing issue in making it more difficult to reduce the size of electronic products, for example.

In view of this, a wound coil has been proposed in conventional practice, and this wound coil has a configuration made by winding a conductive wire around a core formed into the shape of a cone or pyramid, as is disclosed in Japanese Laid-open Patent Application No. 2004-6695.

This coil differs from the type having a constant core diameter described above. As shown in FIG. 3, the outside diameter of the coil gradually decreases, and the diameter of the conductive wire wound around the core also gradually decreases. Therefore, one wound coil does not have a single resonance frequency, but rather has multiple different resonance frequencies.

Accordingly, with the type of wound coil in which the outside diameter of the core varies, a single wound coil has multiple different resonance frequencies, unlike the above-described type in which the core has a constant outside diameter. The functions of an inductor can be satisfactorily attained in a proportionately much wider frequency band with a single wound coil, and significant attenuation can be achieved in a large frequency band.

Various developments have been proposed for this type of wound coil, which has attenuation characteristics that are superior to conventional coils. In such a coil, a core provided with a wound conductive wire is itself placed on a substrate, and the ends of the conductive wire are connected to the circuit wiring of the substrate by soldering, whereby the wound coil is mounted on the substrate.

Therefore, mounting the wound coils manually one by one on the substrate proves extremely troublesome and has poor operability. Moreover, since the core provided with the wound conductive wire is placed on the substrate; i.e., the core provided with the wound conductive wire is in contact with another member (substrate), the attenuation characteristics are affected by this contact with another member, and the original attenuation characteristics of the coil are degraded.

In particular, the effects of contact with another member (degradation of the attenuation characteristics) are more severe in a coil that requires extremely high attenuation characteristics, a coil in which a core on which a conductive wire is wound is shaped into a cone that tapers at the distal end instead of having a constant diameter, whereby the coil is endowed with high attenuation characteristics across a wide frequency band, and other coils that have high-performance attenuation characteristics.

[Patent Reference 1] Japanese Laid-open Patent Application No. 2004-6695

### SUMMARY OF THE INVENTION

The present invention, which is a result of further repeated research and development into wound coils wherein the outside diameter of the core varies as described above, provides an extremely innovative and highly practical wound coil wherein the functions of an inductor are satisfactorily achieved in a wider frequency band than in the conventional example, costs are lower and the assembly space is smaller because significant attenuation is achieved in a wide frequency band by a single wound coil, and electronic products and the like, for example, can easily be reduced in size and weight.

Furthermore, an innovative surface-mounted coil that has the following properties is provided. A wound coil having these superior characteristics is configured so that a core provided with a wound conductive wire is accommodated in a case member, and the ends of the conductive wire of the core are connected to connection terminals at the bottom ends of the case member. This configuration is suitable to be automatically mounted on a substrate by an automatic mounting apparatus, for example, wherein the case member is held by a holding arm (a conveying arm that holds the top surfaces of electronic products in a holding aperture at the distal end) of the automatic mounting apparatus (chip mounter), the case member is automatically conveyed to and placed at a specific position on the substrate where a solder has been supplied in advance, and the circuit wiring of the substrate is connected with the connection terminals at the bottom ends of the case member by reflow soldering to mount the case member on the substrate. Moreover, a winding part of the core around which the conductive wire is wound is fixed on the case member via a non-winding part around which the conductive wire is not wound, whereby the winding part of the core is provided without contacting the case member. Degradation of the attenuation characteristics by contact between the conductive wire wound around the core and the case member or various electronic products outside of the case member can thereby be prevented, and significant attenuation characteristics that have heretofore been unattainable can be achieved in coils automatically mounted on substrates.

A summary of the present invention will be described with reference to the accompanying diagrams.

The present invention relates to a wound coil made by winding a conductive wire 2 around a core 3, wherein the core 3 is shaped having a tapered part 11 in which the outside diameter of the core 3 gradually decreases so that the diameter of the conductive wire 2 wound around the core 3 is not constant but instead gradually decreases; and the tapered part 11 is not tapered so that the outside diameter of the core 3 decreases at a constant rate from a large proximal end to a small distal end, but rather the tapered part 11 is formed into a tapered shape wherein the rate of decrease in the outside diameter of the core 3 is gradually reduced from the large proximal end to the small distal end.

The present invention also relates to the wound coil made by winding a conductive wire 2 around a core 3 according to the first aspect, wherein the core 3 is shaped having a tapered part 11 in which the outside diameter of the core 3 gradually decreases so that the diameter of the conductive wire 2 wound around the core 3 is not constant but instead gradually decreases; and the tapered part 11 is not tapered so that the outside diameter of the core 3 decreases at a constant rate from a large proximal end to a small distal end, but rather the tapered part 11 is formed into a tapered shape wherein the outside diameter of the core 3 decreases at a high rate at the large proximal end and decreases at a lower rate in the small distal end than in the large proximal end.

The present invention also relates to the wound coil according to a second aspect, wherein the rate of decrease in the outside diameter of the core 3 in the tapered part 11 is determined by the formula R=−dr(x)/dx, where R is the rate of decrease, x is the axial length of the core 3, and r is the outside diameter; and the tapered part 11 is formed into a tapered shape so that the rate of decrease in the outside diameter of the core 3 in the tapered part 11 is at least R≧0.

The present invention also relates to the wound coil according to a third aspect, wherein the core 3 has a straight part 12 having a constant outside diameter, and has a shape in which the outside diameter of the core 3 decreases from the end of the straight part 12 in the tapered part 11.

Also, the present invention relates to a surface-mounted coil that is mounted on a substrate 1, and comprises a core 3 provided with a wound conductive wire 2, and a case member 4 for accommodating the core 3, wherein the core 3 is configured so that a non-winding part 3B on which the conductive wire 2 is not wound is integrally provided at a distal end of a winding part 3A on which the conductive wire 2 is wound, and the non-winding part 3B is fixed to the case member 4 to accommodate the winding part 3A of the core 3 in the case member 4 without contact; a connection terminal 5 for connecting with circuit wiring of the substrate 1 is provided to the non-winding part 3B of the core 3 or to the case member 4, and is located at the lower end of the case member 4 for accommodating the core 3; and the conductive wire 2 wound around the winding part 3A of the core 3 is connected with the circuit wiring of the substrate 1 by connecting the end of the conductive wire 2 wound around the winding par 3At of the core 3 to the connection terminal 5, and placing the case member 4 on the substrate 1 and connecting the connection terminal 5 to the circuit wiring of the substrate 1.

The present invention also relates to the surface-mounted coil according to a fifth aspect, wherein the case member 4 is formed into a box shape wherein side walls 4B are perpendicular to a ceiling 4A and a bottom part is open, and the configuration allows the core 3 to be inserted into the case member 4 from the bottom opening of the case member 4.

The present invention also relates to the surface-mounted coil according to a sixth aspect, wherein one side wall 4B of the case member 4 is provided with a contact part 6 for contacting the outer peripheral surface of the non-winding part 3B of the core 3, and the contact part 6 is configured as a positioning part 6 for positioning the core 3 at a specific attachment position on the case member 4 by contacting the outer peripheral surface of the non-winding part 3B of the core 3.

The present invention also relates to the surface-mounted coil according to a seventh aspect, wherein the case member 4 is shaped having a notch 6A that faces upward from the lower edge in part of the side wall 4B, the notch 6A is formed into a groove shape that substantially matches the shape of the non-winding part 3B of the core 3, and the notch 6A is configured as a positioning part 6 wherein the inner surface fits over and contacts the non-winding part 3B of the core 3, and positions the core 3 at a specific attachment position on the case member 4.

The present invention also relates to the surface-mounted coil according to an eighth aspect, wherein the case member 4 is provided with terminal notches 8 extending upward from the bottom edges in parts of the side walls 4B, electroconductive metal members 5A are pressed in and fitted into these terminal notches 8, and connection terminals 5 composed of the electroconductive metal members 5A are formed at the bottom ends of the case member 4.

The present invention also relates to the surface-mounted coil according to any of the fifth through ninth aspects, wherein the outer peripheral surface of the core 3 is coated with a magnetic material 9 or with a magnetic mixture 9 made by mixing a magnetic powder.

The present invention also relates to the surface-mounted coil according to the tenth aspect, wherein the magnetic material 9 or the magnetic mixture 9 made by mixing a magnetic powder is provided on the outer peripheral surface of the winding part 3A of the core 3, in the gaps in the conductive wire 2 wound around the winding part 3A.

The present invention also relates to the surface-mounted coil according to any of the fifth through ninth aspects, wherein a reflecting member 7 having better electromagnetic wave reflection characteristics than the core 3 is provided to the outer peripheral surface of the non-winding part 3B of the core 3, and the reflecting member 7 and conductive wire 2 wound around the core 3 are kept in contact with each other.

The present invention also relates to the surface-mounted coil according to the twelfth aspect, wherein an electrically electroconductive metal member having better electromagnetic wave reflection characteristics than the core 3 is used as the reflecting member 7, the end of the conductive wire 2 wound around the core 3 is connected to the reflecting member 7, and the reflecting member 7 is designed so that the lower end region thereof assumes a position adjacent to or in contact with the substrate 1 when the case member 4 accommodating the core 3 is placed on the substrate 1, so that the reflecting member 7 is configured as the connection terminal 5.

The present invention also relates to the surface-mounted coil according to the tenth aspect, wherein a reflecting member 7 having better electromagnetic wave reflection characteristics than the core 3 is provided to the outer peripheral surface of the non-winding part 3B of the core 3, and the reflecting member 7 and conductive wire 2 wound around the core 3 are kept in contact with each other.

The present invention also relates to the surface-mounted coil according to the fourteenth aspect, wherein an electrically electroconductive metal member having better electromagnetic wave reflection characteristics than the core 3 is used as the reflecting member 7, the end of the conductive wire 2 wound around the core 3 is connected to the reflecting member 7, and the reflecting member 7 is designed so that the lower end region thereof assumes a position adjacent to or in contact with the substrate 1 when the case member 4 accommodating the core 3 is placed on the substrate 1, so that the reflecting member 7 is configured as the connection terminal 5.

The present invention also relates to the surface-mounted coil according to the eleventh aspect, wherein a reflecting member 7 having better electromagnetic wave reflection characteristics than the core 3 is provided to the outer peripheral surface of the non-winding part 3B of the core 3, and the reflecting member 7 and conductive wire 2 wound around the core 3 are kept in contact with each other.

The present invention also relates to the surface-mounted coil according to a sixteenth aspect, wherein an electrically electroconductive metal member having better electromagnetic wave reflection characteristics than the core 3 is used as the reflecting member 7, the end of the conductive wire 2 wound around the core 3 is connected to the reflecting member 7, and the reflecting member 7 is designed so that the lower end region thereof assumes a position adjacent to or in contact with the substrate 1 when the case member 4 accommodating the core 3 is placed on the substrate 1, so that the reflecting member 7 is configured as the connection terminal 5.

The present invention also relates to the surface-mounted coil according to any of the fifth through seventeenth aspects, wherein the core 3 having a tapered shape according to the third aspect is used as the core 3 accommodated in the case member 4.

The present invention also relates to the surface-mounted coil according to any of the fifth through seventeenth embodiments, wherein the core 3 having a tapered shape according to the fourth aspect is used as the core 3 accommodated in the case member 4.

Since the present invention is configured as described above, the core is formed having a tapered part wherein the outside diameter of the core is not constant but instead gradually decreases, and the diameter of the conductive wire wound around the core also gradually decreases in the tapered part. The coil therefore has not one but multiple different resonance frequencies, similar to a conventional type of wound coil in which the outside diameter of the core varied. Consequently, inductor characteristics can be satisfactorily attained in a proportionately wider frequency band with only one wound coil due to these multiple resonance frequencies, and higher attenuation characteristics can be achieved in a wider frequency band.

There is also no need for multiple wound coils each having a single different resonance frequency, and significant attenuation is achieved in a wider frequency band with only one coil of the present invention. Costs can therefore be proportionately lowered and the number of coils can be reduced, and so there are no impediments to size reduction normally dealt with in electronic products, and electronic products and the like can be easily made more compact, for example.

Moreover, in the present invention, the tapered part of the core does not have a tapered shape wherein the outside diameter of the core merely decreases at a constant rate from the large proximal end to the small distal end as in conventional practice, but is instead formed into a tapered shape wherein the rate of decrease in the outside diameter of the core is gradually reduced from the large proximal end of the tapered part to the small distal end (i.e., the rate of decrease is high in the large proximal end of the tapered part, for example, the rate of decreases is lower in the small distal end than in the proximal end, and the outside diameter of the core decreases at a high rate in the large proximal end of the tapered part and at a low rate in the distal end), whereby even greater attenuation characteristics are achieved in a wide frequency band. It is therefore possible to easily design a configuration in which greater attenuation characteristics are achieved in a wide frequency band, which has not heretofore been possible in this type of wound coil.

In the present invention, since the tapered part is shaped to allow the conductive wire to be wound more times than on a pillar or cone shape, for example, the conductive wire can of course be wound more times around the core, the core may be made proportionately smaller in length and more compact, and electronic components, for example, can be made compact in a more satisfactory manner.

Consequently, the present invention is a practical and extremely innovative wound coil, wherein a single wound coil has multiple resonance frequencies, significant attenuation can of course be achieved with a proportionately wider frequency band, and the frequency band in which this significant attenuation is achieved can be widened further than in the past. Significant attenuation is therefore achieved in a wider frequency band than in the past, costs are lower, and the coil is more compact.

In the invention according to the fifth aspect, since the core is accommodated in the case member, it is easy to design a configuration wherein the shape of the case member can be suitably designed and can be satisfactorily held by a holding arm of an automatic mounting apparatus known as a chip mounter, for example, and the case member can be automatically conveyed to and placed on a specific position on the substrate in a satisfactory manner (for example, the case member is fashioned into a box shape that is open at the bottom). It is also possible to easily design a configuration that can be automatically mounted on a substrate by a common automatic mounting apparatus.

Since the core is accommodated in the case, the winding part on which the conductive wire of the core is wound can of course be elevated from the substrate without being in contact with the substrate when the case member is placed on the substrate, and the winding part on which the conductive wire is wound is fixed in the case member by means of a non-winding part on which the conductive wire of the core is not wound. The winding part can therefore be free of contact from the case member, the winding part in the case member can be reliably prevented from contacting other electronic components outside of the case member, and the attenuation characteristics can thereby be prevented from degrading due to contact between the winding part of the core and other members (the case member, the substrate, other electronic components, and the like).

Consequently, the present invention is an extremely practical surface-mounted coil that can be automatically mounted in a satisfactory manner on a substrate by a chip mounter or another common automatic mounting apparatus, for example, wherein it is possible to prevent the attenuation characteristics from being degraded due to contact between the winding part of the core and the substrate or other members, and the original attenuation characteristics of the coil can be proportionately attained in an efficient and satisfactory manner.

The invention according to the fifth aspect is an innovative and highly practical surface-mounted coil, in which a core whose distal end has a tapered shape, as does the wound coils of the inventions of the first through fourth aspects described above, is used as the core accommodated in the case member, rather than a core merely having a constant diameter. In this case, a high-performance tapered coil capable of high attenuation characteristics in a wide frequency band can efficiently exhibit the original superior attenuation characteristics without degradation. An extremely practical coil can be achieved, wherein the superior attenuation characteristics can be prevented from being degraded in a tapered coil in which the effects of contact with other members (degradation of attenuation characteristics) is severe because of high functionality, and superior surface mountability and attenuation characteristics are both attained.

The invention according to the sixth aspect is a surface-mounted coil that can be satisfactorily held by a holding arm of a common automatic mounting apparatus, for example, and the coil is therefore suitable as an electronic product that is automatically conveyed onto a substrate by this type of automatic mounting apparatus.

The invention according to the seventh and eighth aspects is more productive and practical, in that the non-winding part is fixed to the case member while the outer peripheral surface of the non-winding part of the core is in a state of contact with the positioning part of the case member at the end. The core can thereby be simply and reliably attached and fixed at the desired attachment position in the case member, and the case member can be mounted on the substrate with proportionately greater precision in the position and axial center direction of the winding part of the core.

The invention according to the ninth aspect can be more easily designed and has superior productivity, in that the case member is shaped having terminal notches at the bottom ends, and electrically electroconductive metal members are pressed in and fitted into these terminal notches, whereby connection terminals can be simply provided to the bottom ends of the case member.

The invention according to the tenth through seventeenth aspects is a more functional and practical surface-mounted coil, wherein reflection characteristics are attained in addition to attenuation characteristics by means of a magnetic member or magnetic mixture made by mixing a magnetic powder formed around the outer peripheral surface of the core, or a reflecting member formed around the outer peripheral surface of the non-winding part of the core. Greater attenuation characteristics are therefore achieved due to the isolation effect of both the attenuation characteristics and the reflection characteristics.

In the invention according to the twelfth, fourteenth, and sixteenth aspects in particular, the reflecting member formed around the outer peripheral surface of the non-winding part of the core does not only exhibit reflection characteristics, but also functions as the connection terminals for connecting the conductive wire of the core and the circuit wiring of the substrate with electrical conduction, resulting in an efficient structure that has minimal losses.

In a configuration that yields greater attenuation characteristics due to the isolation effect as in the invention according to the tenth through seventeenth aspects, the effects of degraded attenuation characteristics are severe in cases in which the conductive wire on the winding part of the core is in contact with the substrate, case member, or another member. However, the present invention is configured to prevent the attenuation characteristics from being degraded due to contact with these other members as described above, so the invention according to the tenth through seventeenth aspects is an even more practical surface-mounted coil wherein the effects of preventing the attenuation characteristics from being degraded by the case member can be even more suitably attained.

### BRIEF DESCRIPTION OF THE DRAWINGS

FIG. 1 is an explanatory front cross-sectional view showing the wound coil according to Embodiment 1;

FIG. 2 is an explanatory front cross-sectional view showing another example of the wound coil according to Embodiment 1;

FIG. 3 is an explanatory front cross-sectional view showing a conventional example;

FIG. 4 is an explanatory view showing the measurement results of a test on the wound coil according to Embodiment 1;

FIGS. 5(a) and 5(b) are diagrams comparing the shapes of wound coils used in a test on the wound coil according to Embodiment 1;

FIG. 6 is an explanatory exploded perspective view of the surface-mounted coil according to Embodiment 1;

FIG. 7 is an explanatory perspective view of the surface-mounted coil according to Embodiment 1;

FIG. 8 is an explanatory front cross-sectional view of the surface-mounted coil according to Embodiment 1;

FIG. 9 is an explanatory side cross-sectional view of the surface-mounted coil according to Embodiment 1;

FIG. 10 is a diagram showing the manner in which the surface-mounted coil according to Embodiment 1 is used;

FIG. 11 is a perspective view of a core 3 provided with the wound conductive wire 2 in the surface-mounted coil according to Embodiment 2;

FIG. 12 is an explanatory exploded perspective view of the surface-mounted coil according to Embodiment 2;

FIG. 13 is an explanatory front cross-sectional view of the surface-mounted coil according to Embodiment 2;

FIG. 14 is a partial enlarged cross-sectional view of the surface-mounted coil according to Embodiment 2;

FIG. 15 is a diagram showing another example of Embodiment 2; and

FIG. 16 is a diagram comparing measured values of attenuation in the wound inductor according to Embodiment 2 with the measured values of attenuation in a case in which the outer peripheral surface of the core 3 is coated with a magnetic mixture 9.

### DESCRIPTION OF THE PREFERRED EMBODIMENTS

Preferred embodiments of the present invention (the manner in which the invention is to be put into practice) will now be described in simplified form while depicting the operation of the present invention with reference to the diagrams.

A conductive wire 2 is wound around a core 3. This core 3 does not merely have a constant outside diameter (is not merely cylindrical, for example), but is rather formed into a shape having a tapered part 11 wherein the outside diameter gradually decreases, and the diameter of the conductive wire 2 wound around the core 3 is also not constant, but instead gradually decreases in the tapered part 11.

Therefore, the change in the outside diameter of the core 3 and the diameter of the wound conductive wire 2 (diameter reduction) results in multiple different resonance frequencies.

Consequently, in cases in which the core 3 is merely cylindrical and the outside diameter is constant as in the conventional example wherein, for example, the outside diameter of the core 3 is constant, the wound conductive wire 2 has a constant diameter and only one resonance frequency, and the function of a coil can be satisfactorily attained and significant attenuation can be achieved in this resonance frequency band. However, a practical problem is that the function of the coil (attenuation) immediately and markedly decreases when the resonance frequency deviates from this band. In the present invention, however, one wound coil has multiple resonance frequencies, and significant attenuation can be achieved in a proportionately larger frequency band as a result.

Moreover, in the present invention, the tapered part 11 of the core 3 is not tapered (shaped as a cone, for example) in a way in which the outside diameter decreases at a constant rate from the large proximal end to the small distal end, but is instead formed into a tapered shape wherein the rate of decrease in the outside diameter of the core 3 is gradually reduced from the large proximal end of the tapered part 11 to the small distal end. Specifically, the tapered part 11 has a tapered shape wherein the outside diameter of the core 3 decreases at a high rate at the large proximal end, and the outside diameter of the core 3 at the small distal end decreases at a lower rate in comparison to the large proximal end.

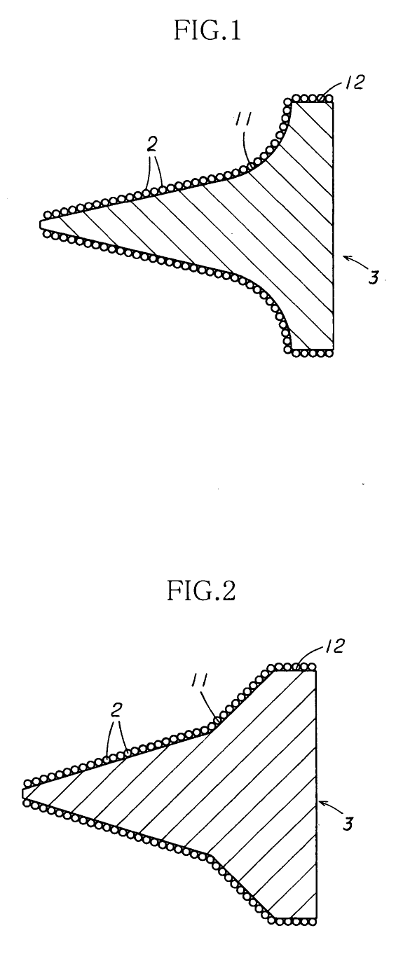

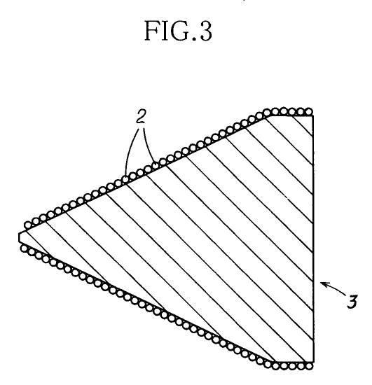

The rate of decrease in the outside diameter of the core 3 in the tapered part 11 is determined by the formula R=−dr(x)/dx, where R is the rate of decrease, x is the axial length of the core 3, and r is the outside diameter, for example. The tapered part 11 can be assumed to be shaped so that the rate of decrease in the outside diameter of the core 3 in the tapered part 11 is at least R≧0 (a hyperboloid shape wherein the rate of decrease diminishes from the proximal end to the distal end as shown in FIG. 1, for example, or an inclined-surface shape having multiple inclined surfaces of different angles of inclination from the proximal end to the distal end as shown in FIG. 2, for example).

Thus, not only is the core 3 shaped to have a tapered part 11 wherein the outside diameter of the core 3 gradually decreases, but the tapered part 11 is also shaped so that the outside diameter of the core 3 decreases at a high rate at the large proximal end, and the outside diameter of the core 3 at the small distal end decreases slowly compared with the proximal end. A more practical wound coil is thereby obtained, wherein greater attenuation can be achieved in a wider frequency band than in a coil 3 having a tapered shape (conical shape) such as is shown in FIG. 3, for example, wherein the diameter merely decreases at a constant rate from the proximal end to the distal end of the tapered part 11.

Particularly, in cases in which the core 3 has a straight part 12 with a constant outside diameter, and the outside diameter of the core 3 decreases in the tapered part 11 from the distal end of the straight part 12, as in the invention according to a fourth aspect, the tapered part 11 is shaped so that the rate of decrease in the outside diameter of the core 3 is gradually reduced from the large proximal end to the small distal end. The result is that attenuation in the resonance frequency band of the straight part 12 of the core 3 increases, and significant attenuation can be achieved in a proportionately wider frequency band.

The tapered part 11 of the core 3 is shaped so that the conductive wire 2 can have a greater number of turns than in the case of a mere pillar shape or conical shape. Therefore, the conductive wire 2 can have a greater number of turns than in conventional practice, for example, despite the fact that the length of the core 3 is the same. The tapered part can also have a compact shape wherein the conductive wire 2 has the same number of turns but the core 3 is set to be smaller in length than in conventional practice. Either case results in a more practical product.

Furthermore, with this type of wound coil, manually mounting coils one by one on a substrate 1 is extremely troublesome, for example, and one concern is that if the core 3 provided with the wound conductive wire 2 is placed on the substrate 1; i.e., if the conductive wire 2 wound on the core 3 is in contact with another member (the substrate 1), then the original attenuation characteristics of the coil will be degraded by the effects of such contact with another member.

In this respect, the present invention comprises a core 3 provided with a wound conductive wire 2, and a case member 4 for accommodating the core 3, wherein the core 3 is configured so that a non-winding part 3B on which the conductive wire 2 is not wound is integrally provided at a distal end of a winding part 3A on which the conductive wire 2 is wound, and the non-winding part 3B is fixed to the case member 4 to accommodate the winding part 3A of the core 3 in the case member 4 without contact; a connection terminal 5 for connecting with circuit wiring of the substrate 1 is provided to the non-winding part 3B of the core 3 or to the case member 4, and is located at the lower end of the case member 4 for accommodating the core 3; and the conductive wire 2 wound around the winding part 3A of the core 3 is connected with the circuit wiring of the substrate 1 by placing the case member 4 on the substrate 1 and connecting the connection terminal 5 to the circuit wiring of the substrate 1. It is thereby possible to resolve the problems with mounting this type of wound coil on the substrate 1 and to prevent the attenuation characteristics from being degraded.

Specifically, when the case member 4 accommodating the core 3 provided with the wound conductive wire 2 is placed on the substrate 1 and the connection terminal 5 located at the bottom end of the case member 4 is connected to the circuit wiring of the substrate 1, the end of the conductive wire 2 wound on the winding part 3A of the core 3 is connected to the connection terminal 5, so the conductive wire 2 is also connected to the circuit wiring of the substrate 1 as a result.

In other words, the present invention can be mounted on the substrate 1 by placing the case member 4 on the substrate 1 and connecting the connection terminal 5 on the bottom end to the circuit wiring of the substrate 1.

Consequently, if the case member 4 is formed into a box shape wherein side walls 4B are perpendicular to a ceiling 4A and a bottom part is open, and the core 3 is accommodated inside the case member 4 by being inserted in the case member 4 from the bottom opening of the case member 4, for example, then it is possible to produce a surface-mounted coil that is suitable as a component mounted on a substrate 1 and that is easily mounted, wherein automatic mounting (one in which the ceiling 4A of the case member 4 is held from above by a holding arm of an automatic mounting apparatus, and the case member 4 is automatically conveyed to a specific location on the substrate 1 by the holding arm) is made possible by a common automatic mounting apparatus (chip mounter). Thus, it is possible to easily design a configuration in which automatic mounting on the substrate 1 is made possible by an automatic mounting apparatus, wherein the tapered wound coil itself is not merely mounted on the substrate 1, but the core 3 is accommodated in the case member 4. The case member 4 can thereby be automatically placed by the holding arm of the automatic mounting apparatus at a specific location on the substrate 1 where a solder has been supplied in advance, and the connection terminal 5 on the bottom end of the case member 4 can be connected to the circuit wiring of the substrate 1 by reflow soldering to mount the case member on the substrate 1.

Also, in the present invention, the core 3 is accommodated in the case member 4. Therefore, the configuration can be designed so that the winding part 3A of the core 3 provided with the wound conductive wire 2 can be elevated over the substrate 1 when the case member 4 is placed on the substrate 1.

The non-winding part 3B integrated with the end of the winding part 3A of the core 3 provided with the wound conductive wire 2 is fixed to the case member 4, and the winding part 3A is disposed so as to not be in contact with the case member 4. Specifically, since the core 3 is configured, for example, from ferrite or another low-dielectric material, the winding part 3A of the core 3 is fixed to the case member 4 via the low-dielectric non-winding part 3B.

It is also possible to reliably prevent contact between other electronic components and elements outside of the case member 4 and the winding part 3A of the core 3 inside the case member 4.

Therefore, in the present invention, the winding part 3A of the core 3 can be mounted on the substrate 1 without coming into contact with the substrate 1 or the case member 4. Accordingly, it is possible to prevent the attenuation characteristics from being affected by the winding part 3A of the core 3 coming into contact with another member, and to preserve the original attenuation characteristics of the winding part 3A of the core 3 in an efficient and satisfactory manner.

The winding part 3A and non-winding part 3B of the core 3 are integrated. Therefore, providing a non-winding part 3B separately to the end of the winding part 3A of the core 3 would complicate manufacturing and increase the number of components. However, these problems are not encountered in the present invention because the non-winding part 3B is integrally formed at the end of the winding part 3A merely by not winding the conductive wire 2 around part of the core 3.

Consequently, the present invention provides a surface-mounted coil that is easily mounted and that is extremely suitable for use in cases in which the coil is automatically mounted on the substrate 1 by a chip mounter or another automatic mounting apparatus, for example. The present invention also provides a superior surface-mounted coil wherein the winding part 3A of the core 3 can be satisfactorily prevented from coming into contact with another member and affecting the attenuation characteristics, and the original attenuation characteristics of the coil can be efficiently and satisfactorily preserved.

The present invention may, for example, be configured so that one side wall 4B of the case member 4 is provided with contact parts 6 for contacting the outer peripheral surface of the non-winding part 3B of the core 3, and the contact parts 6 are configured as positioning parts 6 for positioning the core 3 at a specific attachment position on the case member 4 by contacting the outer peripheral surface of the non-winding part 3B of the core 3. In this case, the core 3 can be easily positioned at a specific attachment position on the case member 4 merely by being brought into contact with the positioning parts 6, and the core 3 can easily be fixed in place in the case member 4 at an appropriate attachment position.

Therefore, in cases in which the attenuation characteristics or the effective frequency band (the frequency band in which constant or better attenuation characteristics can be obtained) require high precision, the core 3 must be precisely positioned in relation to the circuit wiring of the substrate 1, and the core 3 must be precisely oriented in the axial direction when the present invention is mounted on the substrate 1. Such precise mounting is difficult to achieve if the position or orientation for attaching the core 3 in the case member 4 is not constant. However, the core 3 can easily be attached and fixed at the desired attachment position in the case member 4 in the present invention, and superior productivity and practicality can be obtained.

Also, in cases in which, for example, either a magnetic material 9 or a magnetic mixture 9 made by mixing a magnetic powder is applied to the outer peripheral surface of the core 3, reflection characteristics are attained wherein the magnetic material 9 or magnetic mixture 9 reflects electromagnetic waves or other noise. Isolation effects are thereby attained from these reflection characteristics in addition to the attenuation characteristics, resulting in further superior attenuation characteristics.

A case may be considered in which a reflecting member 7 having better electromagnetic wave reflection characteristics than the core 3 is provided to the outer peripheral surface of the non-winding part 3B of the core 3, and the reflecting member 7 and conductive wire 2 wound around the core 3 are kept in contact with each other. In this case, the reflecting member 7 provided to the outer peripheral surface of the non-winding part 3B formed at the end of the winding part 3A of the core 3 exhibits reflection characteristics in relation to electromagnetic waves and other noise. Reflection characteristics can therefore also be attained in addition to the attenuation characteristics of the winding part 3A, resulting in a superior surface-mounted coil having a greater function as a coil for eliminating the noise from the circuit wiring of the substrate 1 by means of the isolation effects of both types of characteristics.

A case may also be considered in which an electrically electroconductive metal member having better electromagnetic wave reflection characteristics than the core 3 is used as the reflecting member 7, the end of the conductive wire 2 wound around the core 3 is connected to the reflecting member 7, and the reflecting member 7 is designed so that the lower end region thereof assumes a position adjacent to or in contact with the substrate 1 when the case member 4 accommodating the core 3 is placed on the substrate 1. In this case, the circuit wiring of the substrate 1 can be made electrically conductive and connected to the conductive wire 2 of the core 3 by connecting the lower end of the reflecting member 7 to the circuit wiring. Thus, not only can the reflecting member 7 exhibit reflecting characteristics in relation to the circuit wiring, but the reflecting member can also function as the connection terminal 5 of the case member 4, and an efficient structure having a proportionally lower level of losses can be obtained.

If, for example, the non-winding part 3B of the core 3 provided with the reflecting member 7 is fitted into a notch 6A formed to face upward from the lower edge in part of one side wall 4B of the case member 4, then it is possible to easily design a configuration wherein the core 3 can be easily fixed at the desired attachment position in the case member 4, and the lower end region of the reflecting member 7 provided in the outer peripheral surface of the non-winding part 3B of the core 3 can be positioned at the lower end of the case member 4.

### Embodiment 1

Embodiment 1 of the present invention will now be described with reference to the diagrams.

The example relates to a wound coil made by winding a conductive wire 2 around a core 3. The core 3 can be configured from ferrite or a dielectric substance, and the configuration of a commonly used core 3 can be employed as the wound coil of this type, such as one in which an air-core coil is filled with a mixture of a resin and an iron powder. In the present invention, a core made of ferrite is used. Copper wire is used for the conductive wire 2.

The core 3 is shaped having a tapered part 11 in which the outside diameter of the core 3 gradually decreases, so that the diameter of the conductive wire 2 wound around the core 3 is not constant but instead gradually decreases.

The tapered part 11 formed in the core 3 is not tapered so that the outside diameter of the core 3 decreases at a constant rate from the large proximal end of the tapered part 11 to the small distal end (see FIG. 3), but is instead formed into a tapered shape wherein the rate of decrease in the outside diameter of the core 3 is gradually reduced from the large proximal end of the tapered part 11 to the small distal end.

The rate of decrease in the outside diameter of the core 3 in the tapered part 11 is determined by the formula R=−dr(x)/dx, where R is the rate of decrease, x is the axial length of the core 3, and r is the outside diameter (i.e., the change in the outside diameter of the core 3 decreases at a higher rate as the value (absolute value) of the rate of decrease becomes larger, and, conversely, the change in the outside diameter of the core 3 is slower as the rate of decrease becomes lower).

The tapered part 11 can be formed into a tapered shape wherein the rate of decrease in the outside diameter of the core 3 in the tapered part 11 is at least R≧0. Particularly, in the present embodiment, the tapered part 11 is formed into a tapered shape wherein the rate of decrease is R>0 from the large proximal end of the tapered part 11 to the small distal end.

Therefore, the core is tapered so that there are no regions from the large proximal end of the tapered part 11 to the small distal end where the outside diameter of the core 3 is constant or where the outside diameter of the core 3 expands, but instead the outside diameter of the core 3 constantly decreases from the large proximal end of the tapered part 11 to the small distal end.

Specifically, the tapered part 11 of the core 3 has a tapered shape that decreases in diameter at a high rate at the large proximal end of the tapered part 11 and decreases at a lower rate in the small distal end than in the large proximal end, and is formed into a hyperbolic shape wherein the rate of decrease in the diameter of the core 3 is reduced from the large proximal end to the small distal end of the tapered part 11, as shown in FIG. 1. The tapered part 11 appears in the shape of a circle when viewed in a lateral cross section.

The shape of the tapered part 11 is not limited to the shape described in relation to the present embodiment, and may be a shape wherein the outline of the actual outside diameter is hollowed inward from an imaginary outline connecting the large proximal end of the tapered part to the small distal end. The tapered part 11 of the core 3 may also be formed into an inclined shape having multiple tapered surfaces with different angles of inclination, wherein the large proximal end of the tapered part 11 has a large angle of inclination (a large rate of decrease in diameter), and the small distal end has a smaller angle of inclination (smaller rate of decrease in diameter) than the proximal end, as shown in FIG. 2, for example. Specifically, the tapered end is not limited to a shape in which the rate of decrease in diameter continuously and gradually decreases from the large proximal end to the small distal end as shown in FIG. 1, and may have a shape wherein the rate of decrease in diameter gradually decreases in stages, as in the other example shown in FIG. 2.

The core 3 is formed into a shape wherein conductive wires 2 wound around the core 3 that are adjacent in the length direction (winding axial direction) of the core 3 are not separated from each other, but are instead adjacent to or in contact with each other. Specifically, in cases in which the core is shaped to have regions in which the outside diameter of the core 3 suddenly undergoes an extreme reduction; i.e., to have stepped parts, the conductive wire 2 wound around the top side of the stepped parts and the conductive wire 2 wound around the bottom side are separated, which reduces the function of the coil. The core 3 is therefore formed into a shape devoid of stepped parts which have different outside diameters and in which conductive wires 2 adjacent in the length direction of the core 3 are separated from each other. The core 3 may also be formed into a shape having stepped parts which have different outside diameters and in which conductive wires 2 adjacent in the length direction of the core 3 are separated from each other, thereby constituting a so-called band-pass filter wherein the attenuation of a specified frequency band is severely reduced.

In the present embodiment, the core 3 is formed into a shape provided with a straight part 12 that has a constant outside diameter, wherein the outside diameter of the core 3 decreases in the tapered part 11 past the end of the straight part 12, as shown in FIG. 1.

Specifically, the straight part 12 extends from the large proximal end (see FIG. 1, right side) of the tapered part 11 formed in the core 3. The straight part 12 appears as a circle when viewed in a lateral cross section, similar to the tapered part 11.

The core 3 of the present embodiment is configured with a hyperboloid-shaped tapered part 11 formed from one end of the tapered part 11, as shown in FIG. 1, but may also be formed, for example, having multiple tapered parts 11 (i.e., having a second tapered part formed past the small distal end of the first tapered part, for example). The core 3 may also be shaped as a polygon when viewed in a lateral cross section, rather than a circle.

In the present embodiment, the diameter of the conductive wire 2 wound around the core 3 decreases together with the reduction in the outside diameter of the core 3 in the tapered part 11 as a result of the configuration described above. Therefore, the core has multiple different resonance frequencies rather than a single resonance frequency, and significant attenuation can be achieved in a proportionately wider frequency band.

Moreover, the frequency band in which significant attenuation can be achieved in the core 3 is even wider because the core 3 in the present embodiment has a tapered shape wherein the outside diameter of the core 3 decreases at a high rate in the large proximal end of the tapered part 11, and the diameter decreases at a low rate in the small distal end, as shown in FIG. 1. Specifically, forming the tapered part 11 into a hyperbolic tapered shape in which the rate of decrease in the outside diameter of the core 3 is gradually reduced as shown in FIG. 1 causes the attenuation in the resonance frequency band of the straight part 12 of the core 3 to be greater than in the prior art, wherein the outside diameter of the core 3 merely decreases at a constant rate (see FIG. 3). As a result, significant attenuation is achieved in the present embodiment in an even wider frequency band with only one wound coil.

Moreover, there is no need to connect multiple wound coils, lower costs are incurred, and less space is needed for assembly because significant attenuation is achieved in an even greater frequency band in only one wound coil, as is described above.

The conductive wire 2 can have a greater number of turns around the hyperbolic core 3 shown in FIG. 1 than around the conical core 3 in the conventional example shown in FIG. 3. Therefore, the length of the core 3 can be set smaller to allow the core to be more compact, for example.

Thus, the coil of the present embodiment is an innovative wound coil that is extremely effective and practical.

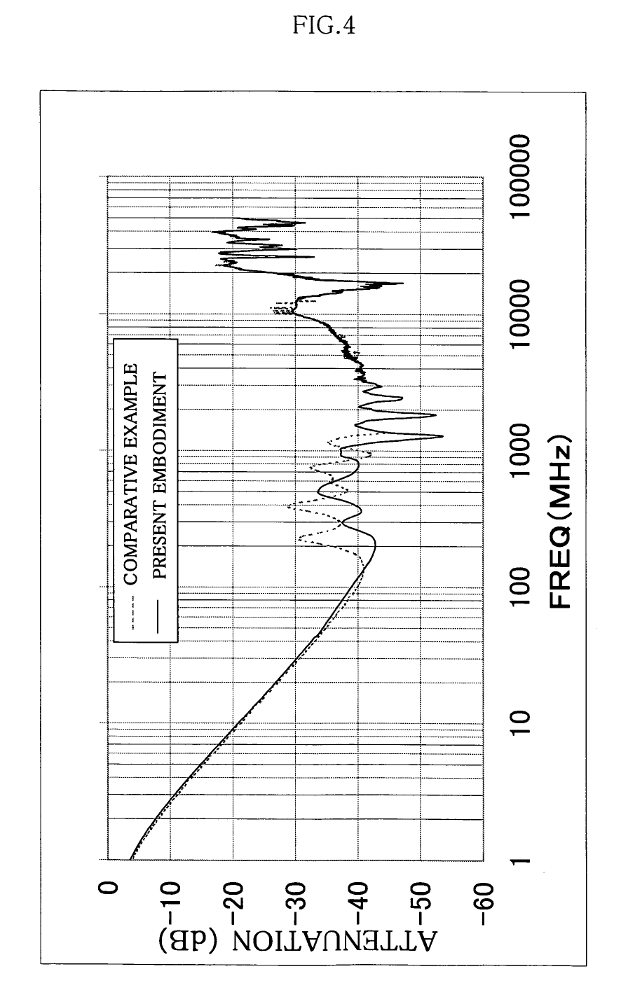

FIG. 4 shows the measurement results obtained by testing and evaluating the attenuation characteristics of the embodiment described above. This diagram shows the results of evaluating the amount of attenuation (attenuation characteristics) by a network analyzer (high-frequency measuring device) for both the example of the present embodiment shown in FIG. 1 (wherein the coil diameter decreases at a high rate in the proximal end), and an example wherein the coil diameter merely decreases at a constant rate, as in the conventional example shown in FIG. 3. This evaluation was performed while sending a sweep signal from a sweeper (sweep signal generator) to a receiver (signal-receiving apparatus).

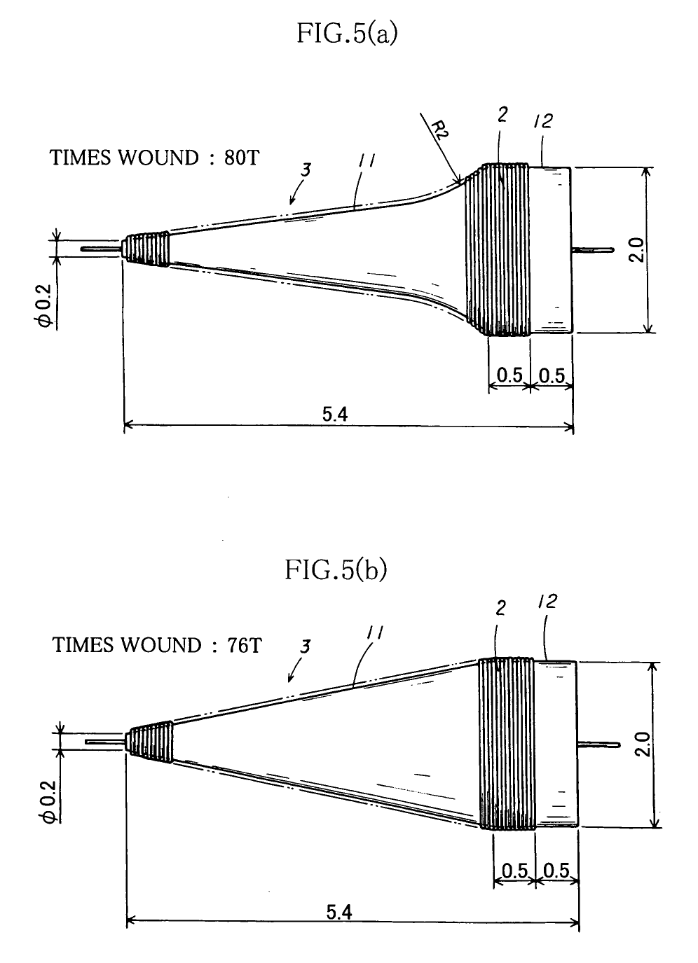

The test conditions are as shown in FIGS. 5(a) and 5a(b). Specifically, the attenuation characteristics were evaluated while the lengths of the cores 3, the proximal diameters, the distal diameters, and the lengths of the cores 3 over which the conductive wires 2 were wound were the same in both cases. The conductive wire 2 wound in the indicated wiring range had 80 turns in the present embodiment, and 76 turns in the comparative example (the conductive wire 2 was wound without any gaps in either case).

As can be seen in FIG. 4, a high attenuation of −30 dB or less can be maintained in a wide frequency range of approximately 30 MHz to approximately 10000 MHz in the present embodiment, while the attenuation was −30 dB or less at about 30 MHz, and was about −28 dB, which is greater than −30 dB, at a frequency of approximately 300 MHz in the comparative example. Thus, significant attenuation characteristics can be maintained in a wider range in the present embodiment than in the conventional example.

Mounting such wound coils manually one at a time on a substrate 1 is extremely troublesome, and if the core 3 provided with a wound conductive wire 2 is placed on a substrate 1; i.e., if the conductive wire 2 wound around the core 3 is in contact with another member (the substrate 1), then the original attenuation characteristics of the coil might be degraded due to the effects of contact with this other member.

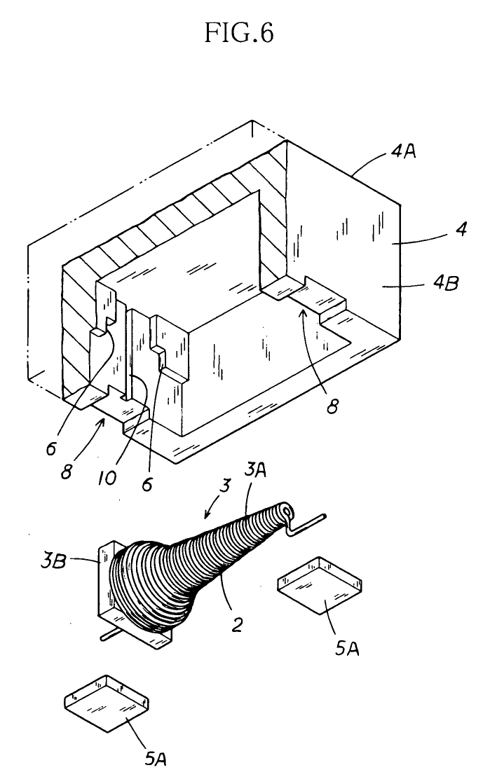

In view of this, as shown in FIG. 6, the present embodiment includes a core 3 provided with a wound conductive wire 2, and a case member 4 for accommodating the core 3, wherein the core 3 is configured so that a non-winding part 3A on which the conductive wire 2 is not wound is integrally provided at an end of a winding part 3A on which the conductive wire 2 is wound, and the non-winding part 3B is fixed to the case member 4 to accommodate the winding part 3A of the core 3 in the case member 4 without contact; a connection terminal 5 for connecting with circuit wiring of the substrate 1 is provided to the non-winding part 3B of the core 3 or to the case member 4, and is located at the lower end of the case member 4 for accommodating the core 3; and the conductive wire 2 wound around the winding part 3A of the core 3 is connected with the circuit wiring of the substrate 1 by placing the case member 4 on the substrate 1 and connecting the connection terminal 5 to the circuit wiring of the substrate 1. The present embodiment is thereby configured as a surface-mounted coil that is suitable to be mounted on the surface of a printed circuit board or another substrate.

This core 3 is formed into a conical shape in which the distal end tapers as described above, and is configured with the large proximal end as the non-winding part 3B on which the conductive wire 2 is not wound, wherein the large non-winding part 3B is provided at the proximal end of the tapered conical winding part 3A. Specifically, the non-winding part 3B is integrally provided in the shape of a square pillar to the large proximal end of the winding part 3A of the core 3, as shown in FIGS. 6 and 8.

Therefore, the winding part 3A and non-winding part 3B of the core 3 of the present embodiment are integrally molded so that the core 3 is composed of a square pillar portion, a cylindrical pillar portion, and a curved cone portion. The non-winding part 3B is integrated with the end of the winding part 3A by winding the conductive wire 2 around only the cylindrical pillar portion and the curved cone portion. There is no need to fix a separate winding part 3A and non-winding part 3B together, and neither is there any danger that these two parts will separate.

The conductive wire 2 wound around the winding part 3A of the core 3 is covered by an insulated film, and the insulated film is removed from only one end. The conductive wire 2 is wound continuously around the winding part 3A of the core 3 so that a specific length of excess wire remains at one end.

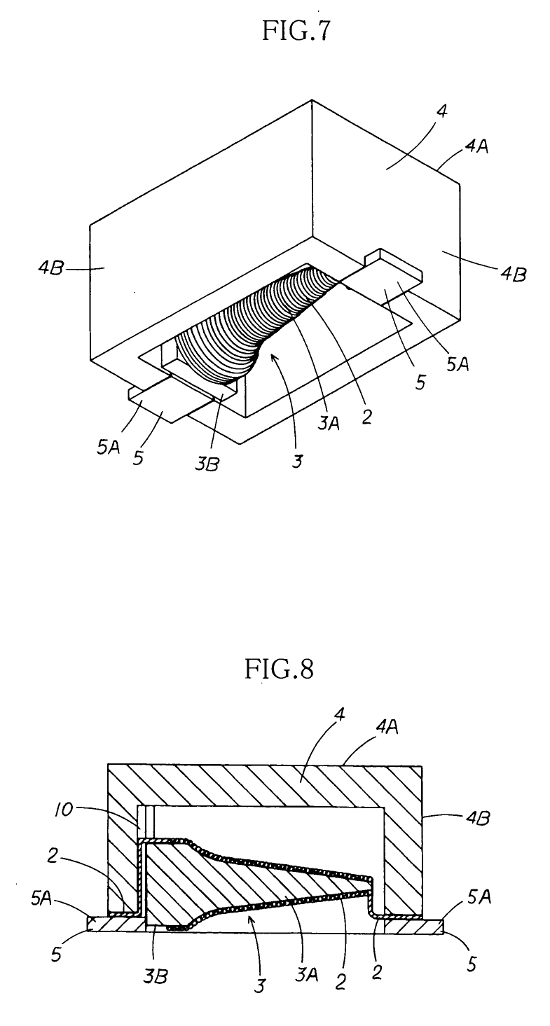

The case member 4 is formed into a box shape wherein the side walls 4B are perpendicular to the ceiling 4A and the bottom is left open, and the core 3 can be inserted into the case member 4 through the bottom opening in the case member 4, as shown in FIGS. 6 and 7. Specifically, the case member has a rectangular parallelepiped shape in which the bottom surface is left open.

Contact parts 6 that contact the outer peripheral surface of the non-winding part 3B of the core 3 are provided in one side wall 4B of the case member 4. Specifically, the contact parts 6 are formed to protrude inward from the side wall 4B of the case member 4, the core 3 is inserted through the bottom opening of the case member 4 so that the end surface of the non-winding part 3B slides along the side wall 4B provided with the contact parts 6 of the case member 4 in a protruding manner, and a pair of left and right protrusions are formed in the side wall 4B of the case member 4 in a protruding manner, opposing each other, to contact and fit over the upper left and right corners on the outer peripheral surface of the square pillar-shaped non-winding part 3B, as shown in FIG. 6.

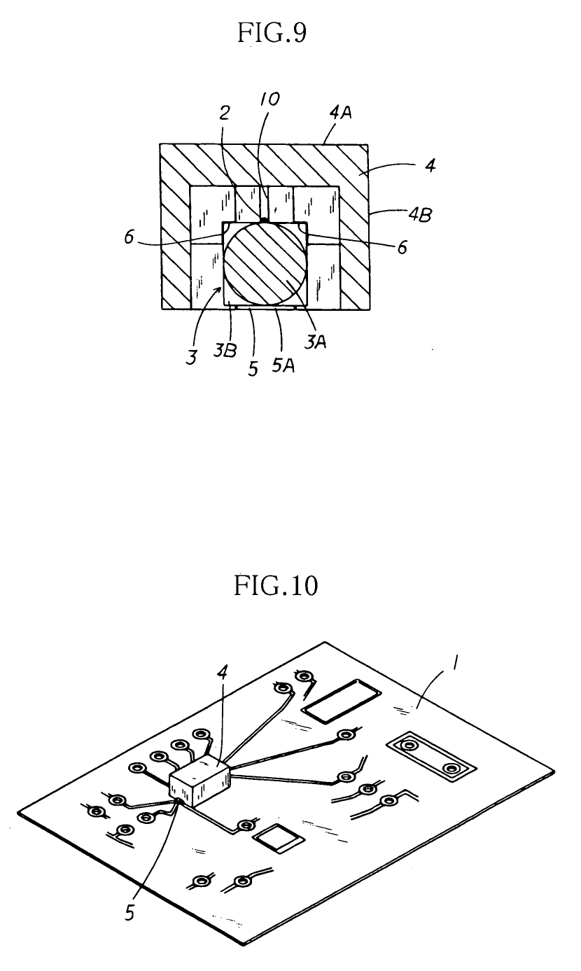

The core 3 is inserted into the case member 4 through the bottom opening in the case member 4 (so that the end surface of the non-winding part 3B of the core 3 slides along the side wall 4B provided with the contact parts 6), and the contact parts 6 are configured as positioning parts 6 for positioning the core 3 at a specific attachment position in the case member 4 by bringing the outer peripheral surface (upper left and right corners) of the non-winding part 3B of the core 3 into contact with the side walls of the pair of protruding contact parts 6 facing each other, as shown in FIG. 9.

Thus, the non-winding part 3B is shaped as a square pillar rather than a cylindrical pillar, and the corners (upper left and right corners) of the non-winding part 3B are positioned and contacted by the positioning parts 6. Therefore, the core 3 can be prevented from coming out of alignment or from rotating while the core 3 is in contact with the contact parts 6, and the core can be simply and reliably positioned at a specific attachment position.

In a configuration wherein the outer peripheral surface of the non-winding part 3B of the core 3 contacts the positioning parts 6 and the end surface of the non-winding part 3B is brought into contact along the side wall 4B of the case member 4 in order to fix the core to the case member (in the present embodiment, the case member 4 and the core 3 are fixed together with an adhesive), the core 3 provided with the wound conductive wire 2 is slightly elevated from the open bottom surface of the case member 4, and the length direction of the rectangular parallelepiped case member 4 is parallel to the axial length of the core 3.

Therefore, when the case member 4 on which the core 3 is fixed is placed on the substrate 1, the core 3 (including the conductive wire 2 wound around the winding part 3A of the core 3) does not come into contact with the surface of the substrate 1 below. If the length direction of the case member 4 is parallel to the length direction of the circuit wiring of the substrate 1, then the axial direction of the core 3 is also set to be parallel to the length direction of the circuit wiring.

The case member 4 also has terminal notches 8 formed in parts of the side walls 4B, and these notches extend upward from the bottom edges. Specifically, these terminal notches 8 are formed as notches extending upward from the centers of the bottom edges of the side walls 4B at the lengthwise ends of the case member 4, as shown in FIG. 6.

Electroconductive metal members 5A are pressed in and fitted into these terminal notches 8, and these electroconductive metal members 5A are configured as connection terminals 5.

In the present embodiment, the ends of the conductive wire 2 wound around the core 3 are disposed in the terminal notches 8, and the electroconductive metal members 5A are pressed in and fitted into the grooves as well, whereby the ends of the conductive wire 2 and the electroconductive metal members 5A are connected together by pressing the ends of the conductive wire 2 and the electroconductive metal members 5A together in the terminal notches 8.

Therefore, in the present embodiment, the connection terminals 5 can be provided at the bottom edges of the case member 4, and the connection terminals 5 can at the same time be connected with the ends of the conductive wire 2 of the core 3 merely by pressing the electroconductive metal members 5A into the terminal notches 8.

The case member 4 is integrally molded from a low-dielectric resin.

The numerical symbol 10 in the diagram denotes a wire-laying concavity 10 for receiving the excess end of the conductive wire 2 not wound around the winding part 3A of the core 3, and bringing out the end part to the terminal notch 8.

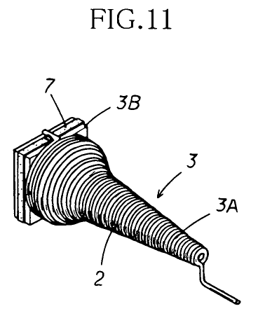

Since the present embodiment is configured as described above, the case member is mounted on the substrate 1 as shown in FIG. 10 by holding the ceiling 4A of the case member 4 with the holding arm of a chip mounter or another automatic mounting apparatus, automatically conveying and mounting the case member at a specific position on the substrate 1 (where a solder for reflow soldering has been provided in advance), and connecting the circuit wiring of the substrate 1 with the connection terminals 5 provided at the lower ends of the case member 4 by reflow soldering.

Since the present embodiment is configured as described above, the winding part 3A of the core 3 provided with the wound conductive wire 2 does not come into contact with the case member 4, the substrate 1, or other electrical components; the winding part 3A can be prevented from coming into contact with other members and impairing attenuation (attenuation impairment can be minimized); and the superior attenuation characteristics can be satisfactorily attained on the substrate 1.

The top surface of the case member 4 can be held or otherwise handled by an automatic mounting apparatus with a holding arm, automatic mounting is made possible, and other aspects of the mounting operation can be improved.

Another aspect of the present embodiment is that the winding part 3A of the core 3 is shaped so that the distal end is tapered as shown in FIG. 1, rather than merely being provided with a constant diameter, and a conductive wire 2 wound in different winding diameters also has different resonance frequencies. Therefore, greater attenuation characteristics can be attained in a proportionally wider frequency band on the basis of these different resonance frequencies. However, in a coil structure that is provided with superior attenuation characteristics in this manner, the effects of the winding part 3A of the core 3 coming into contact with another member (degradation of the attenuation characteristics, reduction of the effective frequency band, and the like) increase proportionately, and problems are usually encountered with degradation of attenuation characteristics when mounted. However, in the present embodiment, the degradation of attenuation characteristics can be suppressed by accommodating the core 3 in the case member 4 as described above, and it is therefore possible to efficiently and satisfactorily attain superior attenuation characteristics on the substrate 1 by suppressing degradation of the original attenuation characteristics in such a highly functional coil structure. The present embodiment therefore has superior mounting operability and attenuation characteristics, and is extremely suitable and practical as this type of substrate-mounted coil.

### Embodiment 2

Embodiment 2 of the present invention will now be described with reference to the diagrams.

The present embodiment is different from Embodiment 1; i.e., a reflecting member 7 having better electromagnetic wave reflection characteristics than the core 3 is formed around the outer peripheral surface of the non-winding part 3B of the core 3, and this reflecting member 7 is connected with the conductive wire 2 wound around the core 3, as shown in FIG. 11.

Therefore, since the reflecting member 7 exhibits reflection characteristics in addition to the attenuation characteristics of the winding part 3A of the core 3, noise in the circuit wiring of the substrate 1 can be more satisfactorily removed by the isolation effect of the attenuation characteristics and the reflection characteristics.

An electrically electroconductive metal member having better electromagnetic wave reflection characteristics than the core 3 is used as the reflecting member 7 (in the present embodiment, a silver film covers the outer peripheral surface of the non-winding part 3B in the shape of a belt).

One end of the conductive wire 2 wound around the core 3 is connected with an electroconductive metal member 5A that constitutes the connection terminal 5 provided at the bottom end of the case member 4, in the same manner as in Embodiment 1, and the other end [of the conductive wire] is connected (by soldering) with the reflecting member 7 (silver film covering) formed around the non-winding part 3B of the core 3.

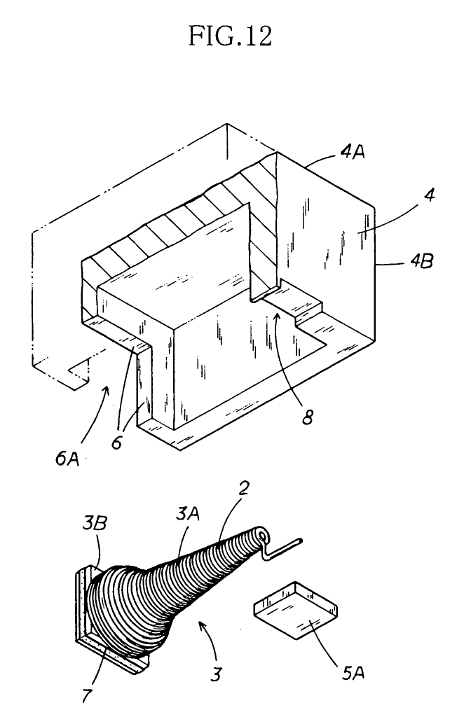

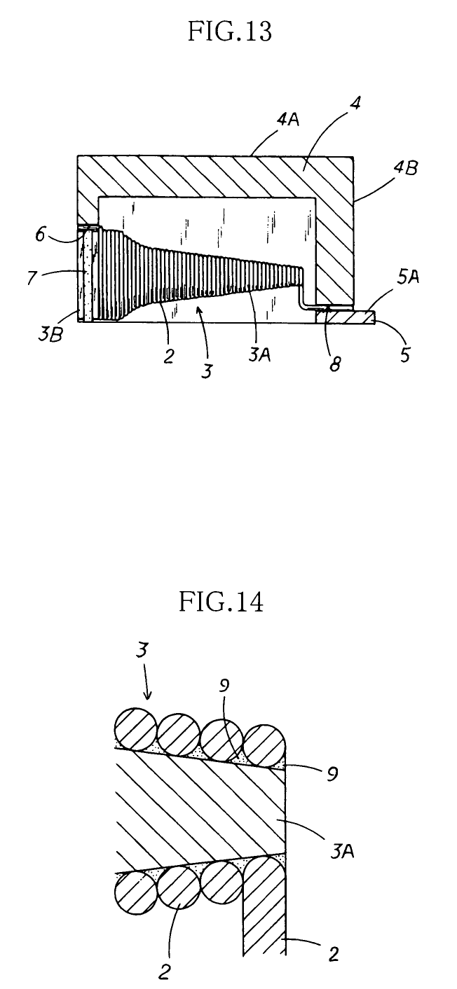

Furthermore, the reflecting member 7 is designed so that the lower end is in a position adjacent to or in contact with the substrate 1 when the case member 4 is mounted on the substrate 1. Specifically, a notch 6A is formed from the bottom edge upward in part of one side wall 4B of the case member 4, and is formed into a groove so as to substantially match the shape of the non-winding part 3B of the core 3, as shown in FIG. 12. The non-winding part 3B of the core 3 fits into this notch 6A, and the bottom edge of the reflecting member 7 formed around the outer peripheral surface of the non-winding part 3B is placed in the same plane as the bottom end surface (bottom opening surface) of the case member 4, as shown in FIG. 13.

Therefore, the case member 4 of the present embodiment is placed on the substrate 1, and the bottom edge of the reflecting member 7 is connected by soldering with the circuit wiring of the substrate 1, whereby the reflecting member 7 fulfills the function of a connection terminal 5 for connecting the circuit wiring with the conductive wire 2.

Also, the inner surface of the notch 6A acts as a positioning part 6 for fitting over and contacting the non-winding part 3B of the core 3 and positioning the core 3 at a specific attachment position in the case member 4. Furthermore, the groove shape of the notch 6A is designed to allow the non-winding part 3B of the core 3 to be pressed and fitted in.

Therefore, the case member 4 and the core 3 can be fitted and fixed together while the non-winding part 3B of the core 3 is in contact with a positioning part 6, which is the inner surface of the notch 6A. This can be achieved merely by pressing the non-winding part 3B of the core 3 into the notch 6A of the case member 4.

Also, the outer peripheral surface of the core 3 is coated with a magnetic material 9, or a magnetic mixture 9 made by mixing a magnetic powder, as shown in FIG. 14.

Specifically, the outer peripheral surface of the winding part 3A of the core 3 is coated with a magnetic mixture 9 made by mixing a magnetic power (iron powder in the present embodiment) with a resin, and the conductive wire 2 is then wound thereon. The magnetic material 9 or the magnetic mixture 9 made by mixing a magnetic powder is thereby provided on the outer peripheral surface of the winding part 3A. The materials fills the gaps in the conductive wire 2 wound around the winding part 3A (i.e., the gaps formed by the outer peripheral surface of the winding part 3A of the core 3 and the conductive wire 2 wound around this outer peripheral surface).

Therefore, the magnetic powder contained in the magnetic mixture 9 displays reflection characteristics by diffusely reflecting noise and other electromagnetic waves. An even more satisfactory noise removal function is achieved based on the isolation effect of the attenuation characteristics and the reflection characteristics.

Since the present embodiment is configured as described above, a reflecting member 7 is provided to the non-winding part 3B integrated with the end of the winding part 3A in order to fix the core 3 in place without contact between the winding part 3A and the case member 4, resulting in a coil structure that has an even more superior noise removal function and has the reflection characteristics of the reflecting member 7 in addition to the attenuation characteristics of the winding part 3A.

Moreover, an efficient, loss-free configuration is achieved because the reflecting member 7 is used as a connection terminal 5 for mounting.

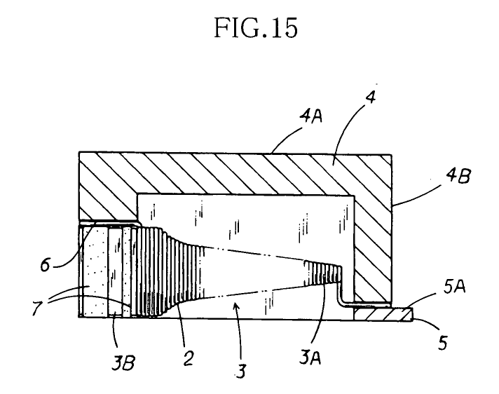

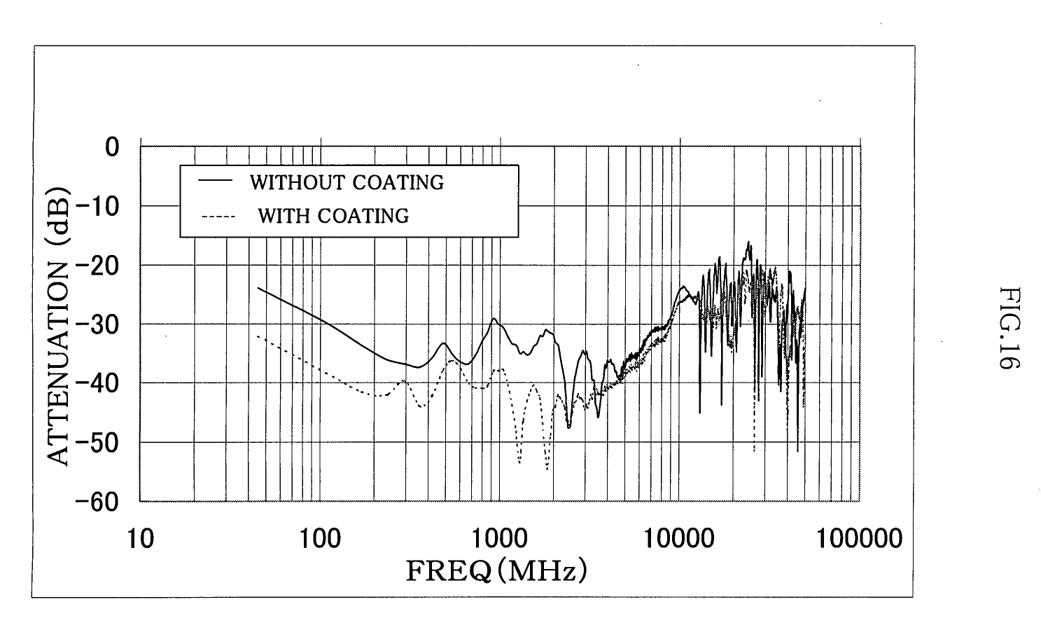

Furthermore, the reflecting member 7 is formed around the outer periphery of the non-winding part 3B of the core 3 in the shape of a belt having a specific width, and the reflection characteristics can be appropriately adjusted merely by suitably setting the belt width of the reflecting member 7 (for example, satisfactory reflection characteristics are obtained in a high-frequency band when the belt width is reduced, and in a low-frequency band when the belt width is increased). Furthermore, a reflecting member 7 having different belt widths can be formed around the non-winding part 3B as shown, for example, in FIG. 15, and the coil characteristics can be adjusted in a simple manner by the reflecting member 7, which is even more practical.

The present embodiment is otherwise identical to Embodiment 1.

FIG. 16 shows the measured values of the attenuation characteristics in a case in which the magnetic mixture 9 is applied over the winding part 3A of the core 3 in Embodiment 2, and also in a case in which no magnetic mixture is applied.

The attenuation characteristics were tested in cases in which the magnetic mixture 9 was applied and not applied, and it was found that the range in which significant attenuation of −30 dB or less was continuously achieved is much wider in the case of applying the magnetic mixture 9 than in the case of not applying the magnetic mixture, as shown in FIG. 16.

The present invention is not limited to Embodiment 1 or 2, and the specific structural elements thereof can be appropriately modified.

What is claimed is:

1. A wound coil made by winding a conductive wire around a core, wherein
the core is shaped having a tapered part in which the outside diameter of the core gradually decreases so that the winding diameter of the conductive wire wound around the core is not constant but instead gradually decreases; and
the tapered part is not tapered so that the outside diameter of the core decreases at a constant rate from a large proximal end to a small distal end, but rather the tapered part is formed into a tapered shape wherein the rate of decrease in the outside diameter of the core is gradually reduced from the large proximal end to the small distal end.

2. The wound coil made by winding a conductive wire around a core according to claim 1, wherein
the core is shaped having a tapered part in which the outside diameter of the core gradually decreases so that the winding diameter of the conductive wire wound around the core is not constant but instead gradually decreases; and
the tapered part is not tapered so that the outside diameter of the core decreases at a constant rate from a large proximal end to a small distal end, but rather the tapered part is formed into a tapered shape wherein the outside diameter of the core decreases at a high rate at the large proximal end and decreases at a lower rate in the small distal end than in the large proximal end.

3. The wound coil according to claim 2, wherein
the rate of decrease in the outside diameter of the core in the tapered part is determined by the formula R=−-dr(x)/dx, where R is the rate of decrease, x is the axial length of the core, and r is the outside diameter; and
the tapered part is formed into a tapered shape so that the rate of decrease in the outside diameter of the core in the tapered part is at least R≧0.

4. The wound coil according to claim 3, wherein the core has a straight part having a constant outside diameter, and has a shape in which the outside diameter of the core decreases from the end of the straight part in the tapered part.

5. A surface-mounted coil that is mounted on a substrate, comprising:
a core provided with a wound conductive wire; and
a case member for accommodating the core, wherein
the core is configured so that a non-winding part on which the conductive wire is not wound is integrally provided at a distal end of a winding part on which the conductive wire is wound, and the non-winding part is fixed to the case member to accommodate the winding part of the core in the case member without contact;
a connection terminal for connecting with circuit wiring of the substrate is provided to the non-winding part of the core or to the case member, and is located at the lower end of the case member for accommodating the core; and
the conductive wire wound around the winding part of the core is connected with the circuit wiring of the substrate by connecting the end of the conductive wire wound around the winding part of the core to the connection terminal, and placing the case member on the substrate and connecting the connection terminal to the circuit wiring of the substrate.

6. The surface-mounted coil according to claim 5, wherein
the case member is formed into a box shape wherein side walls are perpendicular to a ceiling and a bottom part is open; and
the configuration allows the core to be inserted into the case member from the bottom opening of the case member.

7. The surface-mounted coil according to claim 6, wherein
one side wall of the case member is provided with a contact part for contacting the outer peripheral surface of the non-winding part of the core; and
the contact part is configured as a positioning part for positioning the core at a specific attachment position on the case member by contacting the outer peripheral surface of the non-winding part of the core.

8. The surface-mounted coil according to claim 7, wherein
the case member is shaped having a notch that faces upward from the lower edge in part of the side wall;
the notch is formed into a groove shape that substantially matches the shape of the non-winding part of the core; and
the notch is configured as a positioning part wherein the inner surface fits over and contacts the non-winding part of the core, and positions the core at a specific attachment position on the case member.

9. The surface-mounted coil according to claim 8, wherein
the case member is provided with terminal notches extending upward from the bottom edges in parts of the side walls;
electroconductive metal members are pressed in and fitted into these terminal notches; and
connection terminals composed of the electroconductive metal members are formed at the bottom ends of the case member.

10. The surface-mounted coil according to any of claims 5 through 9, wherein the outer peripheral surface of the core is coated with a magnetic material or with a magnetic mixture made by mixing a magnetic powder.

11. The surface-mounted coil according to claim 10, wherein the magnetic material or the magnetic mixture made by mixing a magnetic powder is provided on the outer peripheral surface of the winding part of the core, in the gaps in the conductive wire wound around the winding part.

12. The surface-mounted coil according to any of claims 5 through 9, wherein
a reflecting member having better electromagnetic wave reflection characteristics than the core is provided to the outer peripheral surface of the non-winding part of the core; and
the reflecting member and conductive wire wound around the core are kept in contact with each other.

13. The surface-mounted coil according to claim 12, wherein
an electrically electroconductive metal member having better electromagnetic wave reflection characteristics than the core is used as the reflecting member;
the end of the conductive wire wound around the core is connected to the reflecting member; and
the reflecting member is designed so that the lower end region thereof assumes a position adjacent to or in contact with the substrate when the case member accommodating the core is placed on the substrate, so that the reflecting member is configured as the connection terminal.

14. The surface-mounted coil according to claim 10, wherein
a reflecting member having better electromagnetic wave reflection characteristics than the core is provided to the outer peripheral surface of the non-winding part of the core; and
the reflecting member and conductive wire wound around the core are kept in contact with each other.

15. The surface-mounted coil according to claim 14, wherein
an electrically electroconductive metal member having better electromagnetic wave reflection characteristics than the core is used as the reflecting member;
the end of the conductive wire wound around the core is connected to the reflecting member; and
the reflecting member is designed so that the lower end region thereof assumes a position adjacent to or in contact with the substrate when the case member accommodating the core is placed on the substrate, so that the reflecting member is configured as the connection terminal.

16. The surface-mounted coil according to claim 11, wherein
a reflecting member having better electromagnetic wave reflection characteristics than the core is provided to the outer peripheral surface of the non-winding part of the core; and
the reflecting member and conductive wire wound around the core are kept in contact with each other.

17. The surface-mounted coil according to claim 16, wherein
an electrically electroconductive metal member having better electromagnetic wave reflection characteristics than the core is used as the reflecting member;
the end of the conductive wire wound around the core is connected to the reflecting member; and
the reflecting member is designed so that the lower end region thereof assumes a position adjacent to or in contact with the substrate when the case member accommodating the core is placed on the substrate, so that the reflecting member is configured as the connection terminal.

18. The surface-mounted coil according to any of claims 5 through 17, wherein the core having a tapered shape according to claim 3 is used as the core accommodated in the case member.

19. The surface-mounted coil according to any of claims 5 through 17, wherein the core having a tapered shape according to claim 4 is used as the core accommodated in the case member.
